(19) United States
(12) Patent Application Publication
(10) Pub. No.: US 2021/0190327 A1
(43) Pub. Date: Jun. 24, 2021

(54) DOMESTIC APPLIANCE DEVICE

(71) Applicant: BSH Hausgeräte GmbH, Munich (DE)

(72) Inventors: Jorge Felices Betran, Huesca (Spain) (ES); Juan Jose Galindo Perez, Zaragoza (ES); Pablo Jesus Hernandez Blasco, Zaragoza (ES); Izaskun Jaca Equiza, Zaragoza (ES); Ignacio Lope Moratilla, Zaragoza (ES); Damaso Martin Gomez, Zaragoza (ES)

(21) Appl. No.: 17/053,372

(22) PCT Filed: May 24, 2019
(86) PCT No.: PCT/IB2019/054316

§ 371 Date: Nov. 6, 2020

(30) Foreign Application Priority Data
Jun. 21, 2018 (ES) P201830619

(51) Int. Cl. F24C 15/34; H05B 6/12

(52) U.S. Cl. CPC F24C 15/34; F24C 15/021; H05B 6/129

(57) ABSTRACT

A household appliance device includes a first structural unit, a second structural unit, and an insulation unit configured to provide an insulation between the first and second structural units. The insulation unit includes a placement assist element configured to tailor an exterior shape of the insulation unit to the first structural unit for placement of the insulation unit, and an expansion compensation element configured to compensate at least substantially a thermal expansion of at least one subregion of the insulation unit.

The invention relates to a household appliance device as claimed in claim 1.

A household appliance device configured as an oven device with an insulation unit is already known from the prior art. The insulation unit is provided for electrical insulation between a first structural unit, which is configured as an oven muffle, and a second structural unit, which is configured as an induction heating cable of the oven. In a mounted state the insulation unit is largely arranged between the first structural unit and the second structural unit. In a mounted state the insulation unit is arranged flat on a wall of the first structural unit. When the insulation unit is subject to thermal heating, for example due to a cooking operation taking place in the muffle, there is a risk that the insulation unit will undergo deformation, which could adversely affect the optimal arrangement of the induction heating cable arranged above the insulation unit relative to the muffle.

It is the object of the invention in particular to provide a generic device with an advantageous construction. According to the invention the object is achieved by the features of claim 1, while advantageous configurations and developments of the invention will emerge from the subclaims.

A household appliance device, in particular a household cooking appliance device, advantageously an oven device and preferably an induction oven device, is proposed, with at least one insulation unit, which is provided for in particular electrical and/or thermal insulation between at least one first structural unit and at least one second structural unit and which has at least one placement assist element, which is provided to tailor an exterior shape and/or form of the insulation unit to the first structural unit for the purpose of placing the insulation unit, and at least one expansion compensation element, which is provided to compensate at least substantially for thermal expansion of at least one subregion of the insulation unit.

Such a configuration results in an advantageous construction. In particular the expansion compensation element can in particular specifically prevent deformation of the insulation unit, ensuring an optimal arrangement of the second structural unit relative to the first structural unit and/or optimal heating of items to be cooked within the first structural unit even at high temperatures. The placement assist element allows the insulation unit to be arranged in particular flexibly and/or on any subregion of the first structural unit, in particular irrespective of the form of the structural unit in the subregion. In particular optimal, in particular electrical and/or thermal, insulation is possible between the first structural unit and the second structural unit, allowing a durable configuration to be achieved.

A “household appliance device”, in particular a “cooking appliance device”, advantageously an “oven device” and particularly advantageously an “induction oven device” refers in particular to at least one part, in particular a subassembly, of a household appliance, in particular of a cooking appliance, advantageously of an oven and particularly advantageously of an induction oven. For example a household appliance having the household appliance device could be a chest freezer and advantageously a refrigerator and/or freezer cabinet. Alternatively or additionally a household appliance having the household appliance device could be in particular a cleaning appliance, for example a dishwasher and/or a washing machine and/or a tumble dryer. A household appliance having the household appliance device is advantageously a cooking appliance. A household appliance configured as a cooking appliance could be for example a cooktop, preferably an induction cooktop, and/or a microwave and/or a grill appliance and/or a steam cooking appliance. A household appliance configured as a cooking appliance is advantageously an oven and preferably an induction oven.

For example the second structural unit could be larger than the first structural unit. The first structural unit is advantageously larger than the second structural unit. The expression that an object is “larger” than another object means in particular that the object has a mass and/or volume that is at least 110%, in particular at least 120%, advantageously at least 150%, particularly advantageously at least 175%, preferably at least 200% and particularly preferably at least 250% of the mass and/or volume of the other object.

For example the first structural unit could be arranged above the second structural unit in an installed position. In an installed position the second structural unit is arranged in particular above the first structural unit.

The household appliance device in particular has the first structural unit. The first structural unit could be for example a receiving plate and/or a cooktop plate, which could be provided in particular to receive cooking utensils. The first structural unit is advantageously a muffle, which in particular at least partially defines and/or delimits a cooking space, which is provided in particular for the introduction of items to be cooked, in particular for the purpose of heating and/or cooking. The expression that the muffle “at least partially” defines and/or delimits a cooking space means in particular that the muffle defines and/or delimits the cooking space alone and/or together with at least one further unit, for example with at least one door.

The household appliance device in particular has the second structural unit. The second structural unit could be for example an electronics unit and/or a control unit and/or an operator interface. The second structural unit is advantageously at least one heating unit. A “heating unit” in this context refers in particular to a unit which is provided to supply energy to at least one object to be heated for the purpose of heating the object to be heated in at least one operating state. For example the heating unit could be configured as a resistance heating unit, provided in particular to convert energy to heat and supply said heat to the object to be heated for the purpose of heating the object to be heated. Alternatively or additionally the heating unit could be configured as an induction heating unit, provided in particular to supply energy in the form of an electromagnetic alternating field to the object to be heated, it being possible for the energy supplied to the object to be heated to be converted to heat in particular in the object to be heated. The object to be heated could be for example a cooking utensil and/or at least one wall, in particular at least one muffle wall.

In particular the insulation unit is arranged at least largely between the first structural unit and the second structural unit in at least one mounted state. When viewing a main extension plane of the insulation unit in a perpendicular manner the insulation unit extends in particular over a portion of at least 20%, in particular at least 40%, advantageously at least 60%, particularly advantageously at least 70% and preferably at least 80% of a surface, in particular a wall, of the first structural unit, on which the insulation unit in particular is arranged. In particular in an installed position when a main extension plane of the insulation unit is viewed in a perpendicular manner a surface extension of the insulation unit is greater than a surface extension of the second structural unit.

A “main extension plane” of an object refers in particular to a plane, which is parallel to a largest side surface of a smallest imaginary geometric cuboid that still encloses the object completely and runs in particular through the center point of the cuboid. “At least largely” means in particular by a portion, in particular a mass portion and/or volume portion, of at least 70%, in particular at least 80%, advantageously at least 90% and preferably at least 95%.

For example the insulation unit could have at least one main function, which could be in particular thermal insulation between the first structural unit and the second structural unit. The insulation unit in particular has at least one main function, which is in particular electrical insulation between the first structural unit and the second structural unit. In particular the insulation unit has at least one secondary function, which is in particular thermal insulation between the first structural unit and the second structural unit, in particular in addition to the main function of electrical insulation between the first structural unit and the second structural unit.

The expression that the insulation unit is provided for insulation “between” at least one first structural unit and at least one second structural unit means in particular that the insulation unit is provided to insulate the first structural unit from the second structural unit and/or to insulate the second structural unit from the first structural unit and/or both to insulate the first structural unit from the second structural unit and the second structural unit from the first structural unit.

In at least one operating state the insulation unit in particular reduces the passage of energy, in particular electrical energy and/or thermal energy, between the first structural unit and the second structural unit in particular measurably, in particular when compared with a configuration that avoids and/or lacks an insulation unit. In at least one operating state the insulation unit in particular takes the energy from the first structural unit and/or the second structural unit and absorbs said energy in particular at least largely and/or in particular prevents a transfer of the energy between the first structural unit and the second structural unit. In particular in at least one operating state the insulation unit reduces the probability of an in particular electrical short circuit between the first structural unit and the second structural unit in particular measurably, in particular when compared with a configuration that avoids and/or lacks an insulation unit. In particular in at least one operating state the insulation unit reduces the probability of a transfer of heat between first structural unit and the second structural unit in particular measurably, in particular when compared with a configuration that avoids and/or lacks an insulation unit.

In particular the placement assist element allows an exterior shape and/or form of the insulation unit to be changed and/or to be tailored to an exterior shape and/or form of the first structural unit. The insulation unit can in particular be kinked and/or bent by means of the placement assist element, in particular in a simple manner. In particular the placement assist element allows at least two subregions of the insulation unit, which can in particular be arranged adjacent to one another in at least one unmounted state, to be arranged one above the other and/or overlapping, in particular in at least one direction which is aligned in particular perpendicular to a main extension plane of at least one of the subregions.

An “unmounted” state, in particular of the insulation unit, refers in particular to a state in which the insulation unit is arranged in particular at least largely within one plane and/or in which the insulation unit is unrolled in particular in one plane. The unmounted state takes place in particular temporally before mounting the insulation unit and/or before arranging the insulation unit on the first structural unit. In the unmounted state, in particular when at least one subregion of the insulation unit is viewed in a perpendicular manner, the insulation unit has a maximum surface extension in a plane spanned by the subregion. In particular the insulation unit is free of kinks and/or undulations and/or bends in the unmounted state.

The expression that the expansion compensation element is provided to “compensate” at least substantially for thermal expansion of at least one subregion of the insulation unit means in particular that in at least one operating state the expansion compensation element at least substantially prevents and/or reduces a transfer of the thermal expansion of the subregion from the subregion to at least one further subregion of the insulation unit that in particular surrounds the subregion and/or adjoins the subregion, in particular when compared with a configuration that avoids and/or lacks the expansion compensation element. In particular in at least one operating state the expansion compensation element at least largely absorbs thermal expansion of the subregion of the insulation unit. In at least one operating state the expansion compensation element in particular reduces thermal expansion of the subregion of the insulation unit, in particular when compared with a configuration that avoids and/or lacks the expansion compensation element.

The expansion compensation element is arranged in particular in a region of the insulation unit, in which maximum thermal stresses occur in the insulation unit in a heating operating state. In particular a longitudinal extension direction of the expansion compensation element is aligned at least substantially perpendicular to a direction of the thermal stresses. The placement assist element is in particular in a region of the insulation unit, in which low thermal stresses occur in the insulation unit in a heating operating state.

A “longitudinal extension direction” of an object refers in particular to a direction aligned parallel to a longest side of a smallest imaginary geometric cuboid that still encloses the object completely. The expression “substantially perpendicular” here in particular defines an alignment of a direction relative to a reference direction, the direction and the reference direction being at an angle of 90°, in particular in one plane, and the angle having a maximum deviation of in particular maximum 8°, advantageously maximum 5° and particularly advantageously maximum 2°.

“Provided” means in particular specifically designed and/or equipped. That an object is provided for a specific function means in particular that the object performs and/or executes said specific function in at least one application and/or operating state.

It is further proposed that a longitudinal extension direction of at least one segment of the placement assist element is aligned at an angle to a longitudinal extension direction of at least one segment of the expansion compensation element in at least one unmounted state. In particular the segment of the placement assist element and the segment of the expansion compensation element are at least largely arranged in an in particular common plane, which is spanned in particular by the insulation unit, in at least one unmounted state. The placement assist element could have for example just one segment, which could at least largely and advantageously completely define in particular a shape and/or form of the placement assist element. Alternatively the placement assist element could have in particular at least two, in particular at least three, advantageously at least four, particularly advantageously at least five, preferably at least seven and particularly preferably multiple segments, which in particular together could at least largely and advantageously completely define a shape and/or form of the placement assist element. The expansion compensation element could have for example just one segment, which in particular could at least largely and advantageously completely define a shape and/or form of the expansion compensation element. Alternatively the expansion compensation element could have in particular at least two, in particular at least three, advantageously at least four, particularly advantageously at least five, preferably at least seven and particularly preferably multiple segments, which in particular together could at least largely and advantageously completely define a shape and/or form of the expansion compensation element. The expression that a direction is aligned “at an angle” to another direction means in particular that the direction is at a minimum angle of more than 0° and maximum 90° to the further direction, in particular in a plane within which the direction and the further direction are arranged and which is spanned in particular by the insulation unit. In particular the longitudinal extension direction of the segment of the placement assist element is at a minimum angle of at least 5°, in particular at least 10°, advantageously at least 15°, particularly advantageously at least 20°, preferably at least 30° and particularly preferably at least 40° to the longitudinal extension direction of the segment of the expansion compensation element in at least one unmounted state. In particular the longitudinal extension direction of the segment of the placement assist element is at a minimum angle of maximum 90°, in particular maximum 85°, advantageously maximum 80°, particularly advantageously maximum 70°, preferably maximum 60° and particularly preferably maximum 50° to the longitudinal extension direction of the segment of the expansion compensation element in at least one unmounted state. This allows the segment of the placement assist element and the segment of the expansion compensation element to be arranged in particular flexibly relative to one another, in particular in such a manner as to ensure optimum functionality of the placement assist element and the expansion compensation element. In particular it allows optimum placement of the insulation unit and/or optimum compensation for thermal expansion of the subregion of the insulation unit.

It is also proposed that the placement assist element has at least one notch in the insulation unit and in particular is formed by at least one notch in the insulation unit in at least one unmounted state. For example the placement assist element could have at least two, in particular at least three, advantageously at least four, particularly advantageously at least five, preferably at least seven and particularly preferably multiple notches, which could in particular transition into one another and which could in particular have different longitudinal extension directions from one another, which could in particular be aligned at an angle to one another. The placement assist element in particular has just one notch, which is configured in particular in a straight line. A “notch” refers in particular to a slit and/or an elongated recess, which could be produced and/or introduced into the insulation unit by means of at least one cutting process and/or by means of at least one process that is not a cutting process. This in particular allows economical and/or simple production. In particular an optimum and/or maximum effect can be achieved in a simple manner, allowing a high level of efficiency in particular to be achieved.

It is also proposed that in at least one unmounted state the placement assist element adjoins a lateral boundary of the insulation unit and in particular from the lateral boundary of the insulation unit, which the placement assist element adjoins in at least one unmounted state, faces in the direction of at least one further lateral boundary of the insulation unit and/or in the direction of an inner region of the insulation unit. A “lateral” boundary of the insulation unit in at least one unmounted state refers in particular to a boundary and/or an edge, which in the unmounted state delimits and/or defines and/or bounds a surface extension of the insulation unit, which the insulation unit spans in particular in the main extension plane when a main extension plane of the insulation unit is viewed in a perpendicular manner. This in particular allows optimum tailoring of an exterior shape of the insulation unit to the first structural unit and/or optimum placement of the insulation unit on the first structural unit. In particular the placement assist element can be produced in a simple and/or uncomplicated manner, as it is possible in particular to ensure easy accessibility when producing the placement assist element.

For example in at least one unmounted state the placement assist element could be aligned at an angle to the lateral boundary of the insulation unit and/or in particular be at a minimum angle of at least substantially 90° to the lateral boundary. In at least one unmounted state the placement assist element is preferably at a minimum angle of at least substantially 45° to the lateral boundary of the insulation unit. “At least substantially” in this context means in particular that a deviation deviates from a predefined value in particular by maximum 25%, preferably maximum 10% and particularly preferably maximum 5% of the predefined value. This in particular allows an exterior shape of the placement assist element to be tailored in particular particularly optimally to the first structural unit.

It is also proposed that in at least one unmounted state the expansion compensation element has at least one material weakening of the insulation unit and in particular is formed by at least one material weakening of the insulation unit. A “material weakening” of an object refers in particular to a subregion of the object, in which the object demonstrates at least a reduced material strength and/or thickness relative to at least one further subregion of the object and/or relative to remaining subregions of the object, which could in particular be greater than the subregion and which could in particular at least largely define and/or form the object. A “thickness” of an object refers in particular to a shortest extension of a smallest imaginary geometric cuboid that still encloses the object. The material weakening could be for example a recess and/or a hole and/or a slit and/or reduced material strength and/or a slot in the insulation unit. The material weakening is advantageously a notch in the insulation unit. This in particular compensates optimally for thermal expansion of at least one subregion of the insulation unit in a simple manner, preventing in particular any deformation of the insulation unit and/or movement of the second structural unit relative to the first structural unit.

In at least one unmounted state the expansion compensation element could for example adjoin a lateral boundary of the insulation unit when a main extension plane of the insulation unit is viewed in a perpendicular manner. In at least one unmounted state the expansion compensation element is preferably arranged completely within a surface extension of the insulation unit in the main extension plane when a main extension plane of the insulation unit is viewed in a perpendicular manner. This in particular allows a high level of stability to be achieved.

For example the household appliance device could have just one, in particular a single insulation unit, in particular the insulation unit. The household appliance device preferably has at least one further insulation unit, which has at least one further placement assist element, which is provided in particular to tailor an exterior shape of the further insulation unit to the first structural unit for the purpose of placing the further insulation unit, and at least one further expansion compensation element, which is provided in particular to compensate at least substantially for thermal expansion of at least one subregion of the further insulation unit and which differs from the insulation unit in at least one feature. This in particular allows an arrangement of at least two insulation units one above the other and/or overlapping, in particular in a direction aligned perpendicular to one of the insulation units, resulting in particular in optimized and/or maximum insulation between the first structural unit and the second structural unit.

In at least one unmounted state the insulation unit and the further insulation unit could for example differ from one another in the number of placement assist elements and/or in the number of expansion compensation elements. Alternatively or additionally in at least one unmounted state the insulation unit and the further insulation unit could for example differ in the arrangement of at least one placement assist element and/or at least one expansion compensation element relative to a lateral boundary of the insulation unit and/or relative to one another. Alternatively or additionally for example the insulation unit and the further insulation unit could differ in surface extension and/or exterior form. In at least one unmounted state the insulation unit and the further insulation unit preferably have at least substantially the same surface extension and advantageously at least substantially the same exterior form. The expression that in at least one unmounted state the insulation unit and the further insulation unit have “at least substantially” the same surface extension means in particular that in at least one unmounted state a quotient of a surface extension of the insulation unit and a surface extension of the further insulation unit has a value of at least 0.9, in particular at least 0.92, advantageously at least 0.94, particularly advantageously at least 0.96, preferably at least 0.98 and particularly preferably at least 0.99 and/or that in at least one unmounted state a quotient of a surface extension of the insulation unit and a surface extension of the further insulation unit has a value of maximum 1.1, in particular maximum 1.08, advantageously maximum 1.06, particularly advantageously maximum 1.04, preferably maximum 1.02 and particularly preferably maximum 1.01. This allows the insulation unit and the further insulation unit to be arranged one above the other and/or overlapping in particular in an optimum manner, in particular allowing an optimized and/or maximum insulation effect.

It is also proposed that in at least one unmounted state when a main extension plane of the insulation unit is viewed in a perpendicular manner and when there is an overlapping arrangement of the insulation unit and the further insulation unit, the placement assist element and the further placement assist element are arranged without overlap. In particular in at least one unmounted state when a main extension plane of the insulation unit is viewed in a perpendicular manner and the overlapping arrangement is present, at least one lateral boundary of the insulation unit and at least one lateral boundary of the further insulation unit, in particular lateral boundaries of the insulation unit and lateral boundaries of the further insulation unit, are located one on top of one another and/or above one another. This prevents direct and/or electrically conducting contact between the first structural unit and the second structural unit in particular in a simple and/or uncomplicated manner, allowing in particular a high level of functionality and/or a high level of viability to be achieved.

It is further proposed that in at least one unmounted state when a main extension plane of the insulation unit is viewed in a perpendicular manner and when there is an overlapping arrangement of the insulation unit and the further insulation unit, the expansion compensation element and the further expansion compensation element are arranged without overlap. This in particular prevents, in particular electrically conducting, contact between the first structural unit and the second structural unit and/or the occurrence of electrical short circuits, allowing in particular a high level of operator convenience and/or a durable configuration and/or a high level of viability to be achieved.

The insulation unit could be configured asymmetrically for example, for example in respect of a center point and/or center of gravity of the insulation unit. In particular in the case of an asymmetrical insulation unit the household appliance device could in particular have at least one second insulation unit, which could be configured identically to the insulation unit. In particular in at least one unmounted state and when there is an overlapping arrangement of the insulation unit and the second insulation unit, the insulation unit and the further insulation unit could be twisted relative to one another, for example by rotating the second insulation unit, in particular about a rotation axis, which is aligned perpendicular to the second insulation unit and runs through a center point and/or center of gravity of the second insulation unit, through an angle of at least substantially 90° and/or at least substantially 180°. In at least one unmounted state and when there is an overlapping arrangement of the insulation unit and the second insulation unit, the placement assist element of the insulation unit and a second placement assist element of the second insulation unit could in particular be arranged without overlap. In at least one unmounted state and when there is an overlapping arrangement of the insulation unit and the second insulation unit, the expansion compensation element of the insulation unit and a second expansion compensation element of the second insulation unit could in particular be arranged without overlap. This in particular reduces storage outlay and/or the number of parts required.

The insulation unit and/or the further insulation unit are preferably configured symmetrically, allowing simple mounting in particular.

For example the insulation unit could be configured as a single piece and the further insulation unit could have at least one further first insulation subelement and at least one further second insulation subelement, which could be provided in particular for modular mounting. Alternatively for example the further insulation unit could be configured as a single piece and the insulation unit could have at least one first insulation subelement and at least one second insulation subelement, which could be provided in particular for modular mounting. The insulation unit is preferably configured as a single piece and in particular the further insulation unit is configured as a single piece, in particular in addition to the first insulation unit. “As a single piece” means in particular at least connected with a material fit, for example by means of a welding process, an adhesion process, an injection process and/or another process that appears expedient to the person skilled in the art, and/or advantageously formed in one piece, for example being produced from one casting and/or being produced using a single or multiple component injection method advantageously from a single blank. This in particular allows stable construction and/or simple production of the insulation unit and/or the further insulation unit to be achieved. This in particular reduces storage outlay and/or the number of parts required.

It is also proposed that the insulation unit and in particular the further insulation unit has at least one first insulation subelement and at least one second insulation subelement, which are provided for modular mounting. In particular the further insulation unit has at least one further first insulation subelement and at least one further second insulation subelement, which are provided in particular for modular mounting. The expression that a first object and a second object are provided for “modular” mounting means in particular that the first object and the second object are provided for mounting following the principle of building sets and/or building blocks and are configured in particular so that the first object and the second object can be put together and/or can interact by way of corresponding interfaces in particular based on a suitable form and/or based on a suitable functionality. This in particular allows a particularly flexible configuration to be achieved.

For example the first insulation subelement and the second insulation subelement could be configured at least substantially and in particular completely identically. The further first insulation subelement and the further second insulation subelement could for example be configured at least substantially and in particular completely identically. In particular the first insulation subelement and the second insulation subelement could differ in at least one feature from the further first insulation subelement and the further second insulation subelement. The first insulation subelement and the second insulation subelement preferably differ from one another in at least one feature, in particular size and/or form. The further first insulation subelement and the further second insulation subelement differ from one another in particular in at least one feature, in particular size and/or form. The feature, in which the insulation subelements in particular differ from one another, could be for example size and/or form. Alternatively or additionally the feature, in which the insulation subelements in particular differ from one another, could be for example an arrangement of at least one placement assist element of in particular any insulation unit relative to a lateral boundary and/or relative to at least one expansion compensation element of the insulation unit. The feature, in which the insulation subelements in particular differ from one another, could alternatively or additionally be for example the arrangement of at least one expansion compensation element of in particular any insulation unit relative to a lateral boundary and/or relative to at least one placement assist element of the insulation unit. This allows in particular an extremely high level of flexibility and/or prevents in particular direct electrical contact between the first structural unit and the second structural unit, in particular when there is an overlapping arrangement of the insulation unit and the further insulation unit.

It is also proposed that the insulation unit and/or the further insulation unit is/are made at least largely of mica, in particular synthetic mica. This allows the insulation unit and/or the further insulation unit to be made in particular at least largely of a material with an optimized price/performance ratio, in particular allowing a high level of economic efficiency to be achieved.

Insulation between the first structural unit and the second structural unit can in particular be perfected in a household appliance, in particular in a household cooking appliance, with at least one inventive household appliance device.

A high degree of safety and/or a high level of viability can be achieved in particular by a method for operating an inventive household appliance device, which has at least one insulation unit, which is provided for insulation between at least one first structural unit and at least one second structural unit, an exterior shape of the insulation unit being tailored to the first structural unit for the purpose of placing the insulation unit and thermal expansion of at least one subregion of the insulation unit being at least substantially compensated for.

The household appliance device here is not restricted to the application and embodiment described above. In particular the household appliance device can have a number of individual elements, parts and units that is different from the number cited herein to comply with a mode of operation described herein.

Further advantages will emerge from the description of the drawing that follows. The drawing shows exemplary embodiments of the invention. The drawing, description and claims contain numerous features in combination. The person skilled in the art will expediently also consider the features individually and bring them together to form meaningful further combinations.

In the drawing:

FIG. 1 shows a schematic diagram of a household appliance with a household appliance device,

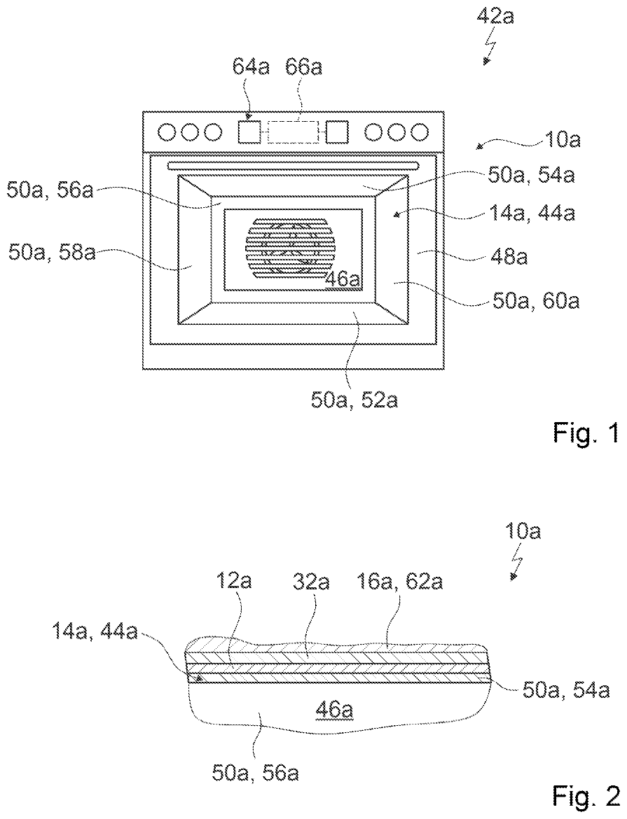

FIG. 2 shows a schematic sectional diagram of a detail of the household appliance,

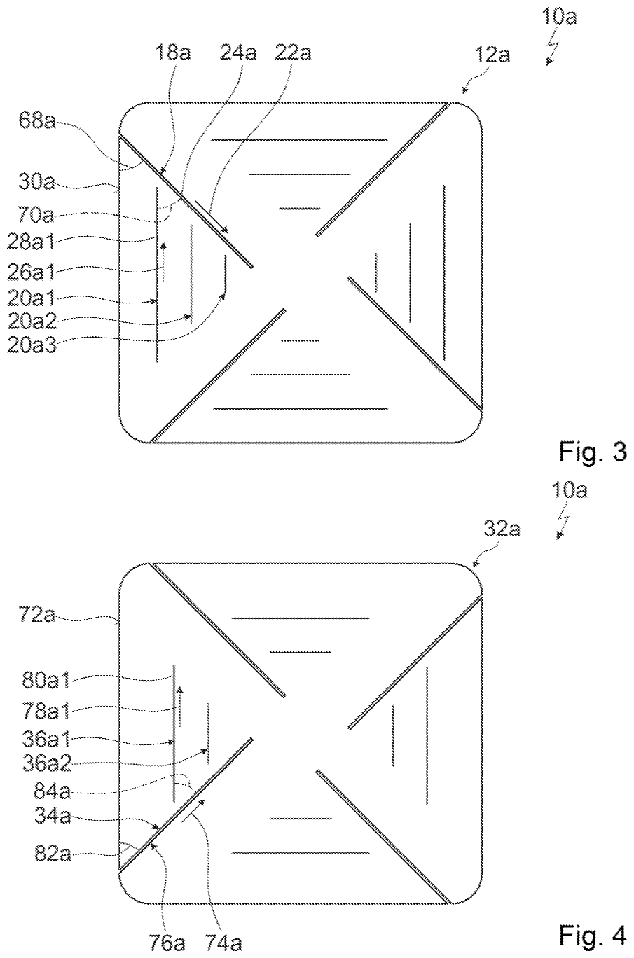

FIG. 3 shows a schematic top view of an insulation unit of the household appliance device in an unmounted state,

FIG. 4 shows a schematic top view of a further insulation unit of the household appliance device in an unmounted state,

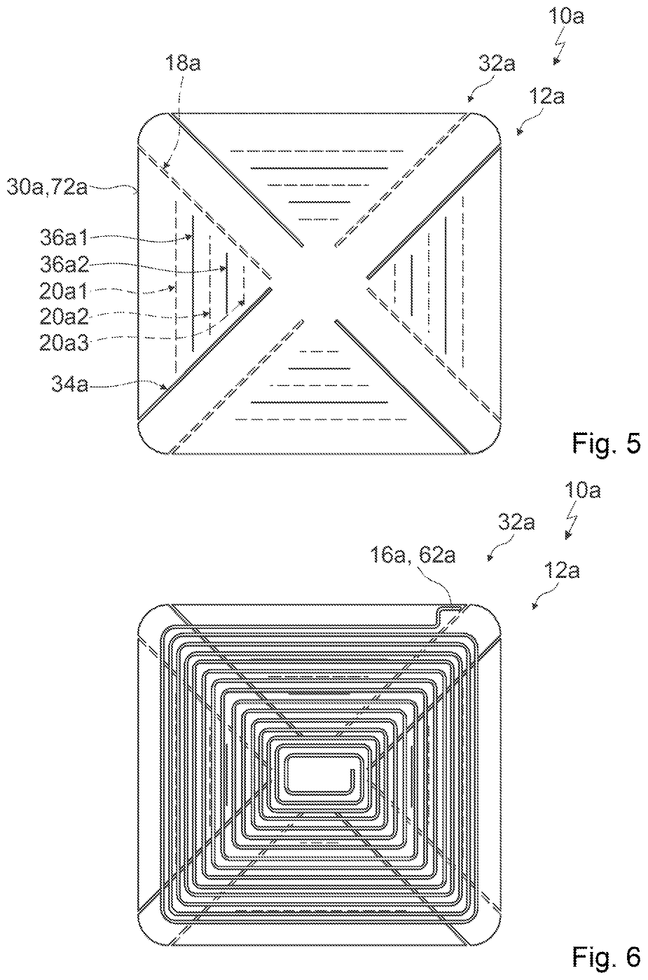

FIG. 5 shows a schematic top view of the insulation unit and the further insulation unit, which are arranged in an overlapping arrangement, in an unmounted state,

FIG. 6 shows a schematic top view of the insulation unit and the further insulation unit, which are arranged in an overlapping arrangement, and a heating unit of the household appliance device in an unmounted state,

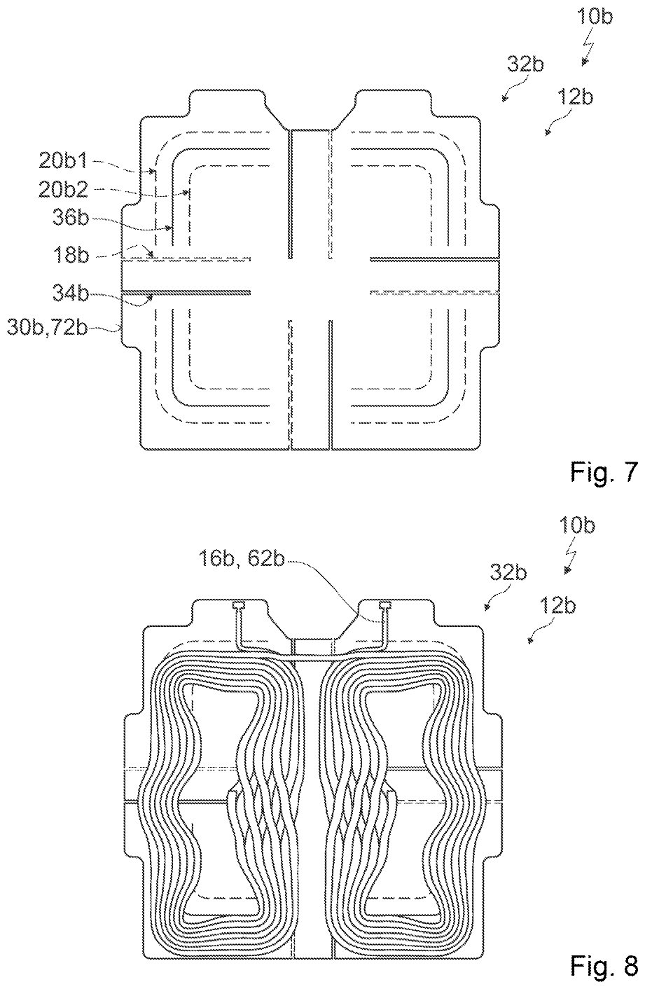

FIG. 7 shows a schematic top view of an insulation unit and a further insulation unit, which are arranged in an overlapping arrangement, and a heating unit of an alternative household appliance device in an unmounted state,

FIG. 8 shows a schematic top view of the insulation unit from FIG. 7 in an unmounted state,

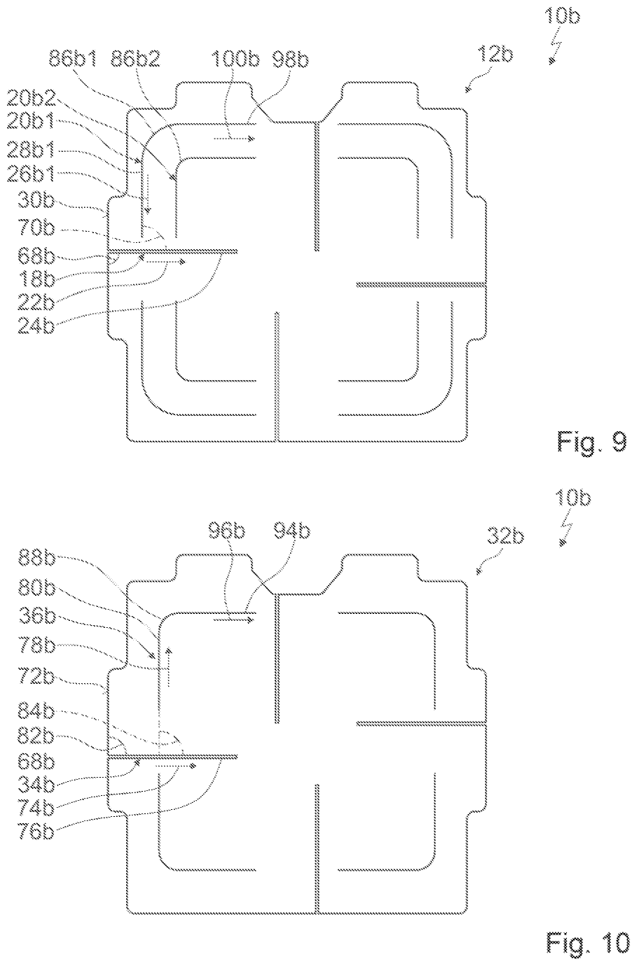

FIG. 9 shows a schematic top view of the further insulation unit from FIG. 7 in an unmounted state,

FIG. 10 shows a schematic top view of an insulation unit and a further insulation unit, which are arranged in an overlapping arrangement, of an alternative household appliance device in an unmounted state,

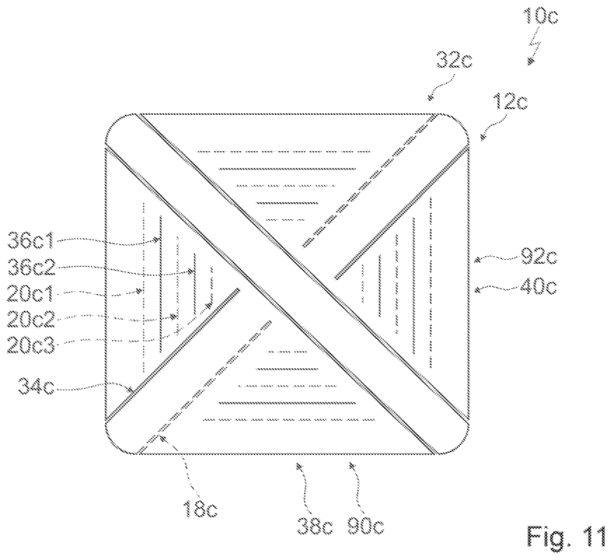

FIG. 11 shows a schematic top view of a first insulation subelement of the insulation unit from FIG. 10 in an unmounted state,

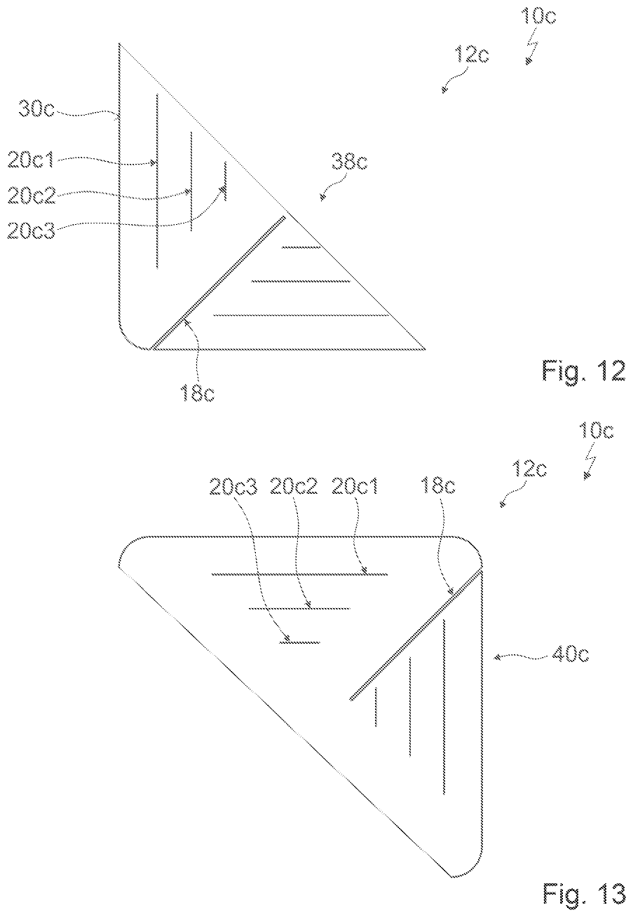

FIG. 12 shows a schematic top view of a second insulation subelement of the insulation unit from FIG. 10 in an unmounted state,

FIG. 13 shows a schematic top view of a further first insulation subelement of the further insulation unit from FIG. 10 in an unmounted state and

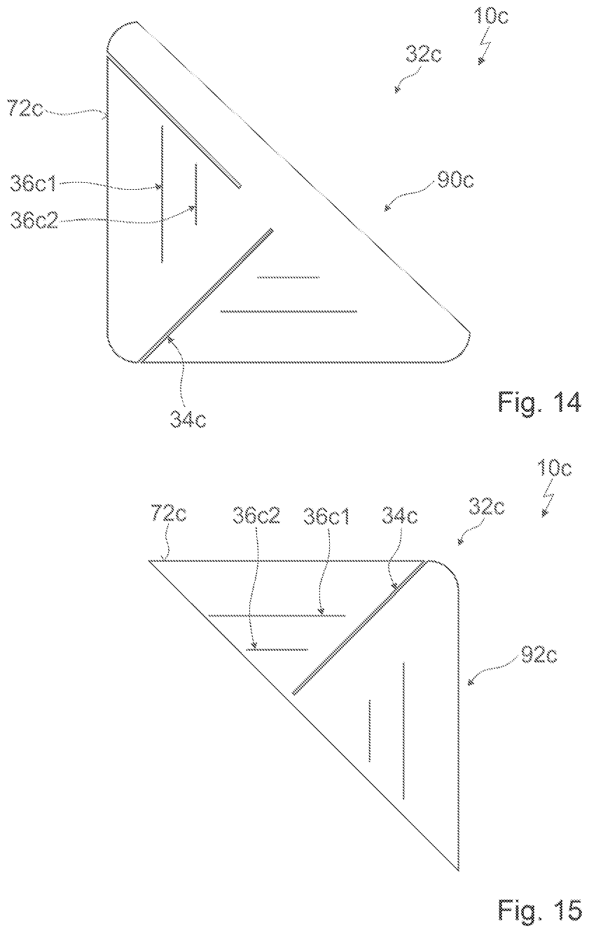

FIG. 14 shows a schematic top view of a further second insulation subelement of the further insulation unit from FIG. 10 in an unmounted state.

FIG. 1 shows a household appliance 42a, which is configured as a household cooking appliance. As an alternative to being configured as a household cooking appliance the household appliance 42a could be configured as a cleaning appliance for example. For example the household appliance 42a configured as a household cooking appliance could be configured as a cooktop, preferably an induction cooktop, and/or a microwave and/or a grill appliance and/or a steam cooking appliance. In the present exemplary embodiment the household appliance 42a is configured as an oven and preferably as an induction oven.

The household appliance 42a has a household appliance device 10a. The household appliance device 10a is configured as a household cooking appliance device. In the present exemplary embodiment the household appliance device 10a is configured as an oven device and preferably as an induction oven device.

The household appliance device 10a has a muffle 44a. The muffle 44a partially delimits a cooking space 46a. The muffle 44a substantially delimits the cooking space 46a together with a cooking appliance door 48a. The household appliance device 10a has the cooking appliance door 48a.

In the present exemplary embodiment the household appliance device 10a has five muffle walls 50a. Where an object is present multiple times in the figures, only one is shown with a reference character. The muffle walls 50a are part of the muffle 44a. The muffle walls 50a together with the cooking appliance door 48a substantially define the cooking space 46a.

One of the muffle walls 50a is configured as a muffle bottom wall 52a. One of the muffle walls 50a is configured as a muffle top wall 54a. One of the muffle walls 50a is configured as a muffle rear wall 56a. Two of the muffle walls 50a are configured as muffle side walls 58a, 60a. Only one of the muffle walls 50a is described in the following.

The household appliance device 10a has an operator interface 64a for inputting and/or selecting operating parameters (see FIG. 1), for example a heating power and/or a heating power density and/or a heating zone. The operator interface 64a is provided to output a value of an operating parameter to an operator.

The household appliance device 10a has a control unit 66a. The control unit 66a is provided to perform actions and/or change settings as a function of operating parameters input by way of the operator interface 64a. In an operating state the control unit 66a regulates an energy supply to at least one heating unit 62a (see FIGS. 2 and 6).

In the present exemplary embodiment the household appliance device 10a has two heating units 62a. Only one of the heating units 62a is shown in the figures. Alternatively the household appliance device 10a could in particular have a different number of heating units 62a. For example the household appliance device 10a could have just one single heating unit 62a. Alternatively the household appliance device 10a could have for example at least three, in particular at least four, advantageously at least five and preferably multiple heating units 62a.

In an operating state the heating units 62a are arranged outside the cooking space 46a. A lower heating unit 62a of the heating units 62a is arranged below the muffle wall 50a configured as a muffle bottom wall 52a in an installed position. The lower heating unit 62a is arranged on the muffle wall 50a configured as a muffle bottom wall 52a.

An upper heating unit 62a of the heating units 62a is arranged above the muffle wall 50a configured as a muffle top wall 54a in an installed position. The upper heating unit 62a is arranged on the muffle wall 50a configured as a muffle top wall 54a.

Alternatively at least one heating unit 62a could be arranged on a muffle wall 50a configured as a muffle side wall 58a, 60a and/or on a muffle wall 50a configured as a muffle rear wall 56a. Only one of the heating units 62a is described in the following.

For example the heating unit 62a could be configured as a resistance heating unit. In the present exemplary embodiment the heating unit 62a is configured as an induction heating unit.

The household appliance device 10a has one insulation unit 12a per heating unit 62a (see FIGS. 2, 3, 5 and 6). The insulation unit 12a is provided for insulation between a first structural unit 14a and a second structural unit 16a. In an operating state the insulation unit 12a insulates the first structural unit 14a and the second structural unit 16a from one another.

The household appliance device 10a has the first structural unit 14a. In the present exemplary embodiment the first structural unit 14a is the muffle 44a.

The household appliance device 10a has the second structural unit 16a. In the present exemplary embodiment the second structural unit 16a is the heating unit 62a.

The insulation unit 12a is provided for electrical insulation between the first structural unit 14a and the second structural unit 16a. In an operating state the insulation unit 12a insulates the first structural unit 14a and the second structural unit 16a electrically from one another.

In particular the insulation unit 12a is provided for thermal insulation between the first structural unit 14a and the second structural unit 16a in addition to the electrical insulation between the first structural unit 14a and the second structural unit 16a. In an operating state the insulation unit 12a insulates the first structural unit 14a and the second structural unit 16a thermally from one another.

In an operating state the insulation unit 12a is largely arranged between the first structural unit 14a and the second structural unit 16a. In an operating state the insulation unit 12a is arranged on the muffle wall 50a of the muffle 44a.

In the present exemplary embodiment the insulation unit 12a has four placement assist elements 18a (see FIGS. 3, 5 and 6). Alternatively the insulation unit 12a could in particular have a different number of placement assist elements 18a. For example the insulation unit 12a could have just one single placement assist element 18a. Alternatively or additionally the insulation unit 12a could have for example at least two and in particular at least four placement assist elements 18a. Alternatively the insulation unit 12a could have for example at least five, in particular at least six, advantageously at least eight and preferably multiple placement assist elements 18a. Only one of the placement assist elements 18a is described in the following.

The placement assist element 18a is provided to tailor an exterior shape of the insulation unit 12a to the first structural unit 14a for the purpose of placing the insulation unit 12a. In an operating state the placement assist element 18a is provided for the purpose of placing the insulation unit 12a in a region of at least one edge and/or unevenness of the first structural unit 14a.

In an unmounted state the placement assist element 18a has a notch in the insulation unit 12a. In an unmounted state the placement assist element 18a is formed by a notch in the insulation unit 12a. In the present exemplary embodiment the placement assist element 18a is configured in a straight line. The placement assist element 18a has just one single segment 24a.

In an unmounted state the placement assist element 18a adjoins a lateral boundary 30a of the insulation unit 12a. In an unmounted state the placement assist element 18a extends from the lateral boundary 30a of the insulation unit 12a in the direction of a center point and/or center of gravity of the insulation unit 12a. In the present exemplary embodiment the placement assist element 18a is at a minimum angle 68a of substantially 45° to the lateral boundary 30a of the insulation unit 12a in an unmounted state.

In the present exemplary embodiment the insulation unit 12a has twelve expansion compensation elements 20. The expansion compensation elements 20a are grouped in four groups. Each group of expansion compensation elements 20a is defined by three expansion compensation elements 20a. The expansion compensation elements 20a of each group differ in respect of a longitudinal extension of the respective expansion compensation elements 20a.

An expansion compensation element 20a1 closest to a lateral boundary 30a of the insulation unit 12a has a greater longitudinal extension than an expansion compensation element 20a3 closest to a center point and/or center of gravity of the insulation unit 12a. The expansion compensation elements 20a of a respective group are grouped with decreasing longitudinal extension from the lateral boundary 30a of the insulation unit 12a in the direction of a center point and/or center of gravity of the insulation unit 12a. A central expansion compensation element 20a2 has a longitudinal extension that is smaller than a longitudinal extension of an expansion compensation element 20a1 closest to the lateral boundary 30a of the insulation unit 12a and greater than a longitudinal extension of an expansion compensation element 20a3 closest to the center point and/or center of gravity of the insulation unit 12a.

The expansion compensation elements 20a of each group are aligned substantially parallel to one another. Only one of the expansion compensation elements 20a is described in the following.

The expansion compensation element 20a is provided to compensate substantially for thermal expansion of at least one subregion of the insulation unit 12a. In an operating state the expansion compensation element 20a allows thermal expansion of the subregion of the insulation unit 12a. In an operating state the expansion compensation element 20a compensates substantially for thermal expansion of at least one subregion of the insulation unit 12a.

In the present exemplary embodiment the expansion compensation element 20a is configured in a straight line. The expansion compensation element 20a has just one single segment 28a. In an unmounted state the expansion compensation element 20a is aligned substantially parallel to a lateral boundary 30a of the insulation unit 12a.

In an unmounted state a longitudinal extension direction 22a of the segment 24a of the placement assist element 18a is aligned at an angle to a longitudinal extension direction 26a of the segment 28a of the expansion compensation element 20a. In the present exemplary embodiment a longitudinal extension direction 22a of the segment 24a of the placement assist element 18a and a longitudinal extension direction 26a of the segment 28a of the expansion compensation element 20a are at a minimum angle 70a of substantially 45° in an unmounted state.

In an unmounted state the expansion compensation element 20a has at least one material weakening of the insulation unit 12a. For example in an unmounted state the expansion compensation element 20a could have a smaller thickness of the insulation unit 12a and/or a recess in the insulation unit 12a. In the present exemplary embodiment in an unmounted state the expansion compensation element 20 has a notch in the insulation unit 12a.

In an unmounted state the expansion compensation element 20a is arranged completely within a surface extension of the insulation unit 12a in the main extension plane when a main extension plane of the insulation unit 12a is viewed in a perpendicular manner. In an unmounted state the expansion compensation element 20a is arranged at a distance from lateral boundaries 30a of the insulation unit 12a when a main extension plane of the insulation unit 12a is viewed in a perpendicular manner.

In addition to the insulation unit 12a the household appliance device 10a has a further insulation unit 32a (see FIGS. 4 to 6). The further insulation unit 32a differs from the insulation unit 12a in at least one feature. The further insulation unit 32a differs from the insulation unit 12a in an arrangement of placement assist elements 18a, 34a relative to a lateral boundary 30a, 72a. In the present exemplary embodiment the further insulation unit 32a differs from the insulation unit 12a in a number of expansion compensation elements 20a, 36a and/or in an arrangement of expansion compensation elements 20a, 36a relative to a lateral boundary 30a, 72a.

In the present exemplary embodiment the further insulation unit 32a has four further placement assist elements 34a. Only one of the further placement assist elements 34a is described in the following.

The further placement assist element 34a is provided to tailor an exterior shape of the further insulation unit 32a to the first structural unit 14a for the purpose of placing the further insulation unit 32a. In an operating state the further placement assist element 34a is provided for the purpose of placing the further insulation unit 32a in a region of at least one edge and/or unevenness of the first structural unit 14a.

In an unmounted state the further placement assist element 34a has a notch in the further insulation unit 32a. In an unmounted state the further placement assist element 34a is formed by a notch in the further insulation unit 32a. In the present exemplary embodiment the further placement assist element 34a is configured in a straight line. The further placement assist element 34a has just one single segment 76a.

In an unmounted state the further placement assist element 34a adjoins a lateral boundary 72a of the further insulation unit 32a. In an unmounted state the further placement assist element 34a extends from the lateral boundary 72a of the further insulation unit 32a in the direction of a center point and/or center of gravity of the further insulation unit 32a. In the present exemplary embodiment in an unmounted state the further placement assist element 34a is at a minimum angle 82a of substantially 45° to the lateral boundary 72a of the further insulation unit 32a.

In the present exemplary embodiment the further insulation unit 32a has eight further expansion compensation elements 36a. The further expansion compensation elements 36a are grouped in four groups. Each group of further expansion compensation elements 36a is defined by two further expansion compensation elements 36a. The further expansion compensation elements 36a of each group differ in respect of a longitudinal extension of the respective further expansion compensation elements 36a.

A further expansion compensation element 36a1 closest to a lateral boundary 72a of the further insulation unit 32a has a greater longitudinal extension than a further expansion compensation element 36a2 closest to a center point and/or center of gravity of the further insulation unit 32a. The further expansion compensation elements 36a of a respective group are grouped with decreasing longitudinal extension from the lateral boundary 72a of the further insulation unit 32a in the direction of a center point and/or center of gravity of the further insulation unit 32a.

The further expansion compensation elements 36a of each group are aligned substantially parallel to one another. Only one of the further expansion compensation elements 36a is described in the following.

The further expansion compensation element 36a is provided to compensate substantially for thermal expansion of at least one subregion of the further insulation unit 32a. In an operating state the further expansion compensation element 36a allows thermal expansion of the subregion of the further insulation unit 32a. In an operating state the further expansion compensation element 36a compensates substantially for thermal expansion of at least one subregion of the further insulation unit 32a.

In the present exemplary embodiment the further expansion compensation element 36a is configured in a straight line. The further expansion compensation element 36a has just one single segment 80a. In an unmounted state the further expansion compensation element 36a is aligned substantially parallel to a lateral boundary 72a of the further insulation unit 32a.

In an unmounted state a longitudinal extension direction 74a of the segment 76a of the further placement assist element 34a is aligned at an angle to a longitudinal extension direction 78a of the segment 80a of the further expansion compensation element 36a. In the present exemplary embodiment a longitudinal extension direction 74a of the segment 76a of the further placement assist element 34a and a longitudinal extension direction 78a of the segment 80a of the further expansion compensation element 36a are at a minimum angle 84a of substantially 45° in an unmounted state.

In an unmounted state the further expansion compensation element 36a has at least one material weakening of the further insulation unit 32a. For example in an unmounted state the further expansion compensation element 36a could have a smaller thickness of the further insulation unit 32a and/or a recess in the further insulation unit 32a. In the present exemplary embodiment in an unmounted state the further expansion compensation element 36 has a notch in the further insulation unit 32a.

In an unmounted state the further expansion compensation element 36a is arranged completely within a surface extension of the further insulation unit 32a in the main extension plane when a main extension plane of the further insulation unit 32a is viewed in a perpendicular manner. In an unmounted state the further expansion compensation element 36a is arranged at a distance from lateral boundaries 72a of the further insulation unit 32a when a main extension plane of the further insulation unit 32a is viewed in a perpendicular manner.

In an unmounted state the insulation unit 12a and the further insulation unit 32a have substantially and advantageously completely the same surface extension (see FIGS. 3 to 6). In an unmounted state the insulation unit 12a and the further insulation unit 32a have substantially and advantageously completely the same exterior form.

When a main extension plane of the insulation unit 12a is viewed in a perpendicular manner and when there is an overlapping arrangement of the insulation unit 12a and the further insulation unit 32a, the placement assist element 18a and the further placement assist element 34a are arranged without overlap in an unmounted state. When there is an overlapping arrangement of the insulation unit 12a and the further insulation unit 32a, lateral boundaries 30a of the insulation unit 12a, in particular all the lateral boundaries 30a of the insulation unit 12a, and lateral boundaries 72a of the further insulation unit 32a, in particular all the lateral boundaries 72a of the further insulation unit 32a, lie on top of one another.

When a main extension plane of the insulation unit 12a is viewed in a perpendicular manner and when there is an overlapping arrangement of the insulation unit 12a and the further insulation unit 32a, the expansion compensation element 20a and the further expansion compensation element 36a are arranged without overlap in an unmounted state. When there is an overlapping arrangement of the insulation unit 12a and the further insulation unit 32a, expansion compensation elements 20a and further expansion compensation elements 36a are arranged in an alternating manner in an unmounted state.

In an unmounted state and with an overlapping arrangement of the insulation unit 12a and the further insulation unit 32a a further expansion compensation element 36a is arranged between every two expansion compensation elements 20a. In an unmounted state and with an overlapping arrangement of the insulation unit 12a and the further insulation unit 32a an expansion compensation element 20a is arranged between every two further expansion compensation elements 36a.

When there is an overlapping arrangement of the insulation unit 12a and the further insulation unit 32a, the placement assist element 18a and the further placement assist element 34a define a substantially right-angled triangle in an unmounted state. In an unmounted state every expansion compensation element 20a and every further expansion compensation element 36a are arranged between the placement assist element 18a and the further placement assist element 34a.

In the present exemplary embodiment the insulation unit 12a is configured as a single piece. The insulation unit 12a is formed from a single piece. In the present exemplary embodiment the insulation unit 12a is largely made of mica, in particular synthetic mica.

FIGS. 7 to 15 show two further exemplary embodiments of the invention. The descriptions which follow are limited substantially to the differences between the exemplary embodiments, it being possible to refer to the description of the exemplary embodiment in FIGS. 1 to 6 for parts, features and functions that remain the same. To differentiate between the exemplary embodiments, the letter a in the reference characters of the exemplary embodiment in FIGS. 1 to 6 is replaced by the letters b and c in the reference characters of the exemplary embodiment in FIGS. 7 to 15. In principle reference can be made to the drawings and/or description of the exemplary embodiment in FIGS. 1 to 6 for parts designated in the same manner, in particular for parts with the same reference characters.

FIG. 7 shows an insulation unit 12b and a further insulation unit 32b, which are arranged in an overlapping arrangement, and a heating unit 62b of an alternative household appliance device 10b in an unmounted state. The further insulation unit 32b differs from the insulation unit 12b in at least one feature. The further insulation unit 32b differs from the insulation unit 12b in an arrangement of placement assist elements 18b, 34b relative to a lateral boundary 30b, 72b. In the present exemplary embodiment the further insulation unit 32b differs from the insulation unit 12b in a number of expansion compensation elements 20b, 36b and/or in an arrangement of expansion compensation elements 20b, 36b relative to a lateral boundary 30b, 72b.

In the present exemplary embodiment the insulation unit 12b has four placement assist elements 18b (see FIGS. 7 and 8). Only one of the placement assist elements 18b is described in the following.

In the present exemplary embodiment the placement assist element 18b is configured in a straight line. The placement assist element 18b has just one single segment 24b.

In an unmounted state the placement assist element 18b adjoins a lateral boundary 30b of the insulation unit 12b. In the present exemplary embodiment the placement assist element 18b is at a minimum angle 68b of substantially 90° to the lateral boundary 30b of the insulation unit 12b in an unmounted state.

In the present exemplary embodiment the insulation unit 12b has eight expansion compensation elements 20b. The expansion compensation elements 20b are grouped in four groups. Each group of expansion compensation elements 20b is defined by two expansion compensation elements 20b. The expansion compensation elements 20b of each group differ in respect of a longitudinal extension of the respective expansion compensation elements 20b.

An expansion compensation element 20b1 closest to a lateral boundary 30b of the insulation unit 12b has a greater longitudinal extension than an expansion compensation element 20b2 closest to a center point and/or center of gravity of the insulation unit 12b.

The expansion compensation elements 20b of each group are aligned substantially parallel to one another. Only one of the expansion compensation elements 20b is described in the following.

In the present exemplary embodiment the expansion compensation element 20b has two segments 28b, 98b. A first segment 28b of the segments 28b, 98b of the expansion compensation element 20b has a longitudinal extension direction 26b, which is aligned perpendicular to a longitudinal extension direction 100b of a second segment 98b of the segments 28b, 98b of the expansion compensation element 20b.

The expansion compensation element 20b has a transition segment 86b, which connects the segments 28b, 98b of the expansion compensation element 20b to one another. The transition segment is configured in the shape of a circular arc, in particular a quarter circular arc. Only one of the segments 28b, 98b of the expansion compensation element 20b is described in the following.

In an unmounted state the segment 28b of the expansion compensation element 20a is aligned substantially parallel to a lateral boundary 30b of the insulation unit 12b. The segment 28b of the expansion compensation element 20b is configured in a straight line.

A longitudinal extension direction 26b of the segment 28b of the expansion compensation element 20b, in particular of each of the segments 28b of the expansion compensation element 20b, is aligned at an angle to a longitudinal extension direction 22b of the segment 24b of the placement assist element 18b in an unmounted state. In the present exemplary embodiment a longitudinal extension direction 26b of the segment 28b of the expansion compensation element 20b, in particular of each of the segments 28b of the expansion compensation element 20b, and a longitudinal extension direction 22b of the segment 24b of the placement assist element 18b are at minimum angle 70b of substantially 90° in an unmounted state.

In the present exemplary embodiment the further insulation unit 32b has four further placement assist elements 34b. In the present exemplary embodiment the further insulation unit 32b has four further expansion compensation elements 36b. Only one of the further placement assist elements 34b and only one of the further expansion compensation elements 36b are described in the following.

In an unmounted state the further placement assist element 34b adjoins a lateral boundary 72b of the further insulation unit 32b. In the present exemplary embodiment in an unmounted state the further placement assist element 24b is at a minimum angle 82b of substantially 90° to the lateral boundary 72b of the further insulation unit 34b.

In an unmounted state the further placement assist element 34b has substantially the same shape and/or alignment and/or form as the placement assist element 18b, for which reason reference should be made in particular to the description relating to the placement assist element 18b.

In the present exemplary embodiment the further expansion compensation element 36b has two segments 80b, 94b. A first segment 80b of the segments 80b, 94b of the further expansion compensation element 36b has a longitudinal extension direction 78b, which is aligned perpendicular to a longitudinal extension direction 96b of a second segment 94b of the segments 80b, 94b of the further expansion compensation element 36b.

The further expansion compensation element 36b has a further transition segment 88b, which connects the segments 80b, 94b of the further expansion compensation element 36b to one another. The further transition segment 88b is configured in the shape of a circular arc, in particular a quarter circular arc. Only one of the segments 80b, 94b of the further expansion compensation element 36b is described in the following.

In an unmounted state the further expansion compensation element 36b has substantially the same shape and/or alignment and/or form as the expansion compensation element 20b, for which reason reference should be made in particular to the description relating to the expansion compensation element 20b.

[symbol]

In an unmounted state and with an overlapping arrangement of the insulation unit 12b and the further insulation unit 32b the further expansion compensation element 36b is arranged between two expansion compensation elements 20b. With an overlapping arrangement of the insulation unit 12b and the further insulation unit 32b the placement assist element 18b and the further placement assist element 34b are aligned substantially parallel to one another in an unmounted state.

FIG. 11 shows an insulation unit 12c and a further insulation unit 32c, which are arranged in an overlapping arrangement, of an alternative household appliance device 10c in an unmounted state. The insulation unit 12c and the further insulation unit 32c are configured in a similar manner to the insulation unit 12a and the further insulation unit 32a from the exemplary embodiment in FIGS. 1 to 6 in respect of an arrangement of placement assist elements 18c, 34c and expansion compensation elements 20c, 36c relative to one another, for which reason reference should be made to the description relating to the exemplary embodiment in FIGS. 1 to 6 here.

In contrast to the configuration of the exemplary embodiment in FIGS. 1 to 6 the insulation unit 12c is configured with multiple parts. In the present exemplary embodiment the insulation unit 12c has a first insulation subelement 38c and a second insulation subelement 40c (see FIGS. 11 to 13). The first insulation subelement 38c and the second insulation subelement 40c are provided for mounting in a modular manner.

The first insulation subelement 38c and the second insulation subelement 40c differ from one another in at least one feature. In the present exemplary embodiment the first insulation subelement 38c and the second insulation subelement 40c differ from one another in size.

In contrast to the configuration of the exemplary embodiment in FIGS. 1 to 6 the further insulation unit 32c is configured with multiple parts. In the present exemplary embodiment the further insulation unit 32c has a further first insulation subelement 90c and a further second insulation subelement 92c (see FIGS. 11, 14 and 15). The further first insulation subelement 90c and the further second insulation subelement 92c are provided for mounting in a modular manner.

The further first insulation subelement 90c and the further second insulation subelement 92c differ from one another in at least one feature. In the present exemplary embodiment the further first insulation subelement 90c and the further second insulation subelement 92c differ from one another in size and/or in number of placement assist elements 18c, 34c.

### REFERENCE CHARACTERS

10 Household appliance device
12 Insulation unit
14 First structural unit
16 Second structural unit
18 Placement assist element
20 Expansion compensation element
22 Longitudinal extension direction
24 Segment
26 Longitudinal extension direction
28 Segment
30 Boundary
32 Further insulation unit
34 Further placement assist element
36 Further expansion compensation element
38 First insulation subelement
40 Second insulation subelement
42 Household appliance
44 Muffle
46 Cooking space
48 Cooking appliance door
50 Muffle wall
52 Muffle bottom wall
54 Muffle top wall
56 Muffle rear wall
58 Muffle side wall
60 Muffle side wall
62 Heating unit
64 Operator interface
66 Control unit
68 Angle
70 Angle
72 Boundary
74 Longitudinal extension direction
76 Segment
78 Longitudinal extension direction
80 Segment
82 Angle
84 Angle
86 Transition segment
88 Further transition segment
90 Further first insulation subelement
92 Further second insulation subelement
94 Segment
96 Longitudinal extension direction
98 Segment
100 Longitudinal extension direction

1-15. (canceled)

16. A household appliance device, comprising:
a first structural unit;
a second structural unit; and
an insulation unit configured to provide an insulation between the first and second structural units, said insulation unit including a placement assist element configured to tailor an exterior shape of the insulation unit to the first structural unit for placement of the insulation unit, and an expansion compensation element configured to compensate at least substantially a thermal expansion of at least one subregion of the insulation unit.

17. The household appliance device of claim 16, constructed in the form of a household cooking appliance device.

18. The household appliance device of claim 16, wherein the placement assist element includes a segment which defines a longitudinal extension direction which is aligned at an angle to a longitudinal extension direction of a segment of the expansion compensation element in an unmounted state.

19. The household appliance device of claim 16, wherein the placement assist element has a notch in the insulation unit in an unmounted state.

20. The household appliance device of claim 16, wherein the placement assist element adjoins a lateral boundary of the insulation unit in an unmounted state.

21. The household appliance device of claim 20, wherein the placement assist element extends at a minimum angle of at least substantially 45° to the lateral boundary of the insulation unit in the unmounted state.

22. The household appliance device of claim 16, wherein the expansion compensation element is formed by a material weakening of the insulation unit in an unmounted state.

23. The household appliance device of claim 16, wherein the expansion compensation element is arranged in an unmounted state completely within a surface extension of the insulation unit in a main extension plane when the main extension plane of the insulation unit is viewed in a perpendicular manner.

24. The household appliance device of claim 16, further comprising a further insulation unit including a further placement assist element and a further expansion compensation element, said further insulation unit having a configuration which differs from a configuration of the insulation unit.

25. The household appliance device of claim 24, wherein the insulation unit and the further insulation unit have at least substantially a same surface extension in an unmounted state.

26. The household appliance device of claim 24, wherein the insulation unit and the further insulation unit overlap one another such that the placement assist element and the further placement assist element are arranged without overlap in the unmounted state, when a main extension plane of the insulation unit is viewed in a perpendicular manner

27. The household appliance device of claim 24, wherein the insulation unit and the further insulation unit overlap one another such that the expansion compensation element and the further expansion compensation element are arranged without overlap in the unmounted state, when a main extension plane of the insulation unit is viewed in a perpendicular manner

28. The household appliance device of claim 16, wherein the insulation unit is configured as a single piece.

29. The household appliance device of claim 16, wherein the insulation unit has a first insulation subelement and a second insulation subelement, said first and second subelements configured to enable mounting in a modular manner.

30. The household appliance device of claim 29, wherein the first insulation subelement has a configuration which differs from a configuration of the second insulation subelement.

31. A household appliance, in particular a household cooking appliance, comprising a household appliance device, said household appliance device comprising a first structural unit, a second structural unit, and an insulation unit configured to provide an insulation between the first and second structural units, said insulation unit including a placement assist element configured to tailor an exterior shape of the insulation unit to the first structural unit for placement of the insulation unit, and an expansion compensation element configured to compensate at least substantially a thermal expansion of at least one subregion of the insulation unit.

32. The household appliance of claim 31, wherein the placement assist element includes a segment which defines a longitudinal extension direction which is aligned at an angle to a longitudinal extension direction of a segment of the expansion compensation element in an unmounted state.

33. The household appliance of claim 31, wherein the placement assist element has a notch in the insulation unit in an unmounted state.

34. The household appliance of claim 31, wherein the placement assist element adjoins a lateral boundary of the insulation unit in an unmounted state.

35. The household appliance of claim 34, wherein the placement assist element extends at a minimum angle of at least substantially 45° to the lateral boundary of the insulation unit in the unmounted state.

36. The household appliance of claim 31, wherein the expansion compensation element is formed by a material weakening of the insulation unit in an unmounted state.

37. The household appliance of claim 31, wherein the expansion compensation element is arranged in an unmounted state completely within a surface extension of the insulation unit in a main extension plane when the main extension plane of the insulation unit is viewed in a perpendicular manner.

38. The household appliance of claim 31, wherein the household appliance device comprises a further insulation unit including a further placement assist element and a further expansion compensation element, said further insulation unit having a configuration which differs from a configuration of the insulation unit.

39. The household appliance of claim 38, wherein the insulation unit and the further insulation unit have at least substantially a same surface extension in an unmounted state.

40. The household appliance of claim 38, wherein the insulation unit and the further insulation unit overlap one another such that the placement assist element and the further placement assist element are arranged without overlap in the unmounted state, when a main extension plane of the insulation unit is viewed in a perpendicular manner.

41. The household appliance of claim 38, wherein the insulation unit and the further insulation unit overlap one another such that the expansion compensation element and the further expansion compensation element are arranged without overlap in the unmounted state, when a main extension plane of the insulation unit is viewed in a perpendicular manner

42. The household appliance of claim 31, wherein the insulation unit is configured as a single piece.

43. The household appliance of claim 31, wherein the insulation unit has a first insulation subelement and a second insulation subelement, said first and second subelements configured to enable mounting in a modular manner.

44. The household appliance of claim 43, wherein the first insulation subelement has a configuration which differs from a configuration of the second insulation subelement.
